(19) United States
(12) Patent Application Publication
(10) Pub. No.: US 2023/0190562 A1
(43) Pub. Date: Jun. 22, 2023

(54) SURGICAL FLUID RETENTION DEVICE AND METHOD OF USE

(71) Applicant: NJS Creations LLC, South Harrison Twp., NJ (US)

(72) Inventors: Sean McMillan, South Harrison Twp., NJ (US); Neil McMillan, South Harrison Twp., NJ (US); Julie McMillan, South Harrison Twp., NJ (US)

(73) Assignee: NJS Creations LLC, South Harrison Twp., NJ (US)

(21) Appl. No.: 18/083,691

(22) Filed: Dec. 19, 2022

Related U.S. Application Data
(60) Provisional application No. 63/292,674, filed on Dec. 22, 2021.

(51) Int. Cl. A61G 13/10; A47G 27/02

(52) U.S. Cl. CPC A61G 13/102; A47G 27/0206

(57) ABSTRACT

A fluid retention device and method of use is defined for retaining surgical fluids used during surgical operations. The device includes a base and a sidewall attached to the base. The sidewall defines a retention area on the base. The sidewall includes a hollow interior that is selectively expanded to raise the sidewall from the base and to define an upstanding perimeter around the retention area. The retention area is sufficient to retain at least one medical personnel and an operating table, supporting a surgical patient. A suction pump may be provided for removing the surgical fluids retained within the retention area and for delivering the fluids outside of the area.

### CROSS REFERENCE TO RELATED APPLICATION

The present application claims the benefit of the filing of U.S. Provisional Patent Application Ser. No. 63/292,674, filed Dec. 22, 2021, which is herein incorporated by reference.

### SUMMARY OF THE INVENTION

A fluid retention device is contemplated for use during surgical procedures. In use, the device retains exasperated and exhausted irrigation fluids for proper disposal.

### BACKGROUND OF THE INVENTION

As an example, during arthroscopic knee surgery fluids, such as a saline solution, are pumped into the patient's knee to expand and irrigate the internal area where surgery is to be performed. The fluids are expelled from the knee through a formed outlet and typically flow into the area adjacent the patient. Other fluids and material may also be exasperated during surgery. A significant portion of the fluids may accumulate on the floor, adjacent the operating table. Presently floor mats, pads and towels are used to absorb these fluids. Suction-pump devices, such as “water bugs”, “water booms”, etc., are also used to help capture or remove the fluid. However, these absorbent materials can create obstacles to movement by the attending medical personnel. The fluids may also cause harm to the floor surface and adjacent medical equipment. Further, clean-up may slow the turn-around time in making the surgery center available for another operation.

### SUMMARY

A fluid retention device is defined for retaining surgical fluids used during surgical operations. The device includes a base and a sidewall attached to the base. The sidewall defines an internal retention area on the base. The sidewall preferably includes a hollow interior that is selectively expanded to raise the sidewall from the base and define an upstanding perimeter around the retention area. The retention area is sufficient to surround at least one medical personnel and an operating table, supporting a surgical patient. A suction pump may be provided for removing the surgical fluids retained within the retention area and for delivering the fluids outside of the area.

In embodiments, the sidewall portion may be defined by at least one hollow chamber forming the interior. Port means may be attached to the sidewall for selectably sealing the hollow chamber. The device may also include in combination a suction pump means for suctioning the surgical fluids within the retention area and for delivering the fluids outside of the retention area. The device may include one or more openings adjacent a portion of the sidewall, providing space for pump tubes to pass therethrough. The at least one opening may be formed at a corner position of the sidewall and further may be formed by a separation between the sidewall and the base. The device in combination may also include a mat structure positioned on a top surface of the base and within the retention area. The mat structure may include a resilient coating that optionally provides a frictional standing surface.

A method of performing a surgical operation including the use of surgical irrigation fluids is defined by providing at least one medical personnel for performing a surgical operation, an operating table, and a fluid retention device defining a retention area surrounding the medical personnel and the operating table. The fluid retention device may include a base and a sidewall attached to the base. The sidewall defines the retention area. The sidewall includes a hollow interior that is expandable to raise the sidewall above a top surface of the base. The medical personnel and the operating table are positioned within the retention area during the surgical operation and sidewall retains the discharged medical fluids.

The method of performing a surgical operation may further include the provision of a suction pump for removing surgical fluids retained within the retention area and for directing the fluids outside of the retention area. Further, a mat structure may be provided on a top surface of the base and within the retention area. The mat structure preferably includes a resilient coating that forms a friction surface for the medical personnel.

### BRIEF DESCRIPTION OF THE DRAWINGS

For the purpose of illustration there is shown in the drawings a number of forms which are presently preferred; it being understood that the invention is not limited to the precise arrangements and instrumentalities shown.

FIG. 1 shows an isometric view of an embodiment of a fluid retention device as contemplated being used in a surgery center.

FIG. 2 is an isometric view of the device embodiment as shown in FIG. 1.

FIG. 3 is a top plan view of the device embodiment as shown in FIGS. 1 and 2.

FIG. 4 is a side elevation of the device embodiment as shown in FIGS. 1-3.

FIG. 5 is a partial cross sectional view of the device embodiment as taken along line 5-5 in FIG. 4.

FIG. 6 is a isometric view of the device embodiment of FIGS. 1-4 including a supplemental floor member, with a partial exploded view of a portion thereof also provided.

FIG. 7 is a isometric view of the device embodiment of FIGS. 1-4 including a supplemental access opening, with a partial exploded view of a portion thereof also provided.

### DETAILED DESCRIPTION

In the drawings, where like numerals identify like elements, there is shown a fluid retention device that is generally designated by the numeral 10. The device 10 is positioned within a surgery center, surgical theatre, or other form of operating room having various medical equipment therein. A patient 12 is supported by an operating table 14 and a surgical drape 16 is positioned over the patient 12. A surgeon or other medical personnel 18 is positioned adjacent the patient 12 and operating table 14. An opening 20 is provided within the drape 16 that exposes an area of the patient 12 where the surgery is to be performed. As an example, the surgeon 18 will perform arthroscopic knee surgery. The opening 20 in the drape 18 is positioned adjacent the knee of the patient 12. In the exemplary use of the invention, certain fluids, primarily a saline solution, are pumped into the area of the surgery, so as to expand the patient's knee and irrigate the internal area where surgery is to be performed. The fluid is expelled from the knee through a formed outlet (not shown) and typically flows out onto the area adjacent the operating table. A significant portion of the fluid is directed toward the floor on which the device 10 is positioned.

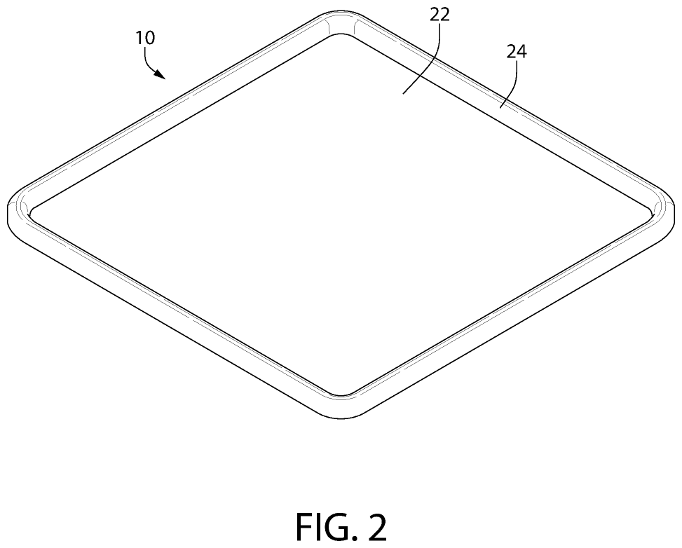

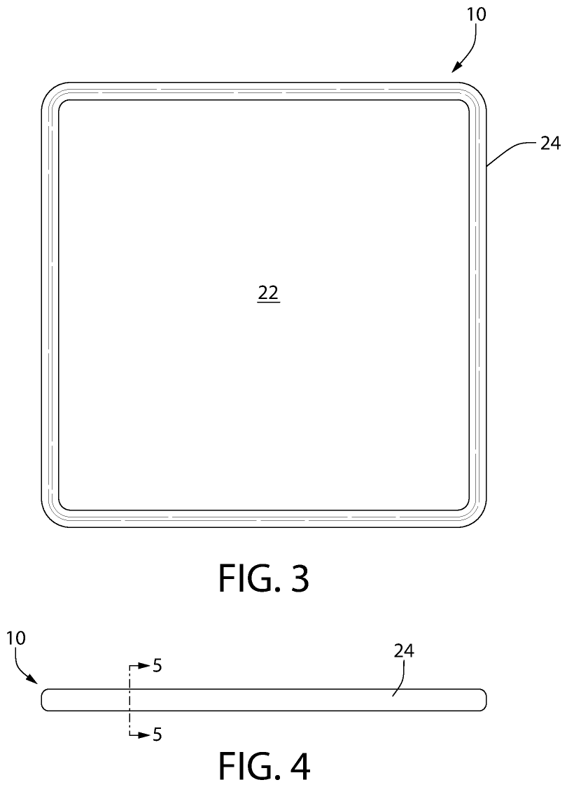

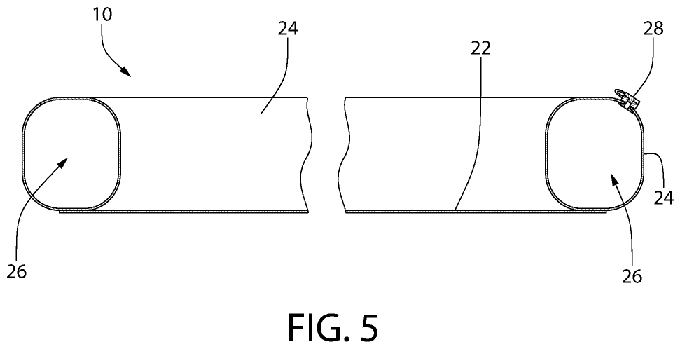

More particularly shown in FIGS. 2-5, the device 10 includes a base 22 and a surrounding sidewall 24, which is connected to the base 22. The sidewall 24 defines the perimeter of the capturing field or retention area of the device 10. Preferably, the perimeter of the base 22 is sealed to the sidewall 24. A valve or similar port means 28 is provided on the sidewall 24, at one or more locations, for the introduction of air or other gas into the sidewall interior 26 to define the perimeter of the retention area. The sidewall 24 is contemplated to be a closed system; thus, the sidewall is air-tight except for the port means 28. The sidewall 24 may define a single chamber or may include a multiple, separate chambers with each having its own port means.

As shown in the cross section of FIG. 5, the interior volume 26 of the sidewall 24 is expanded to create the perimeter barrier for the base 22. Inflation means (not shown) is provided within the surgery center, or separately, to selectively expand the sidewall 24 to form the perimeter barrier around the base 22. The Inflation means may take the form of a mechanical or hand operated pump, or may be a source of compressed air (or other gas). The inflation means is connected to the valve 28 to direct the air into the interior volume 26 of the sidewall 24, so as to expand the sidewall 24. The valve 28 may include a flap or other structure that selectively opens and seals the port. In the closed position, the valve 28 seals the interior volume 26 and the sidewall 24 maintains its expanded condition. The valve 28 may be selectively opened to exhaust the air from the interior 26 of the sidewall 24, so as to permit removal of the device 10 after use.

The base 22 is contemplated to be sufficiently large to permit the operating table 14 and attending medical personnel 18, etc. to stand within the retention area defined by the raised sidewall 22. In one contemplated example, the size of the base may be eighteen (18) feet in length and eight (8) feet in width. The projection of the sidewall 24 is preferably in the range of two to six (2 to 6) inches in height. The height of the sidewall 24 is contemplated to be adjustable dependent on the amount of air (or gas pressure) within the interior volume of the sidewall. In another example, the base may be fourteen (14) feet in length and width. A similar sidewall height is contemplated for this other embodiment. Other shapes and sizes are possible and contemplated. Variations in the dimensions and footprint of the device are generally limited by the area needed to surround medical personnel and the equipment being used during the surgical procedure.

Once the surgery or other procedure is completed, the operating table 14 or a patient transfer vehicle may be wheeled over the sidewall 24, which will collapse at the position of contact. The sidewall 24 may be flexible enough to permit the wheels to roll over the still inflated sidewall 24. The sidewall 24 may alternatively be deflated (in whole or in part) prior to movement of the patient or medical equipment. The fluids retained in the area defined by the sidewall 24 are removed during or after the surgical procedure. Suction may be applied from an external source or otherwise. A exhaust opening may be provided to direct the retained fluids towards a local drain. After exhaust of the retained fluids, the sidewall 24 is collapsed. The device 10 is contemplated to be used in a single surgical procedure before being disposed in a proper manner.

The device 10 is contemplated to be made of a relatively soft, flexible plastic material. The material of both the base 22 and sidewall 24 is preferably a synthetic medical grade plastic that is impervious. Further, the preferred material will have no absorptive capabilities. The sidewall material is preferably brightly colored for visibility. The sidewall is sealed to the based to prevent fluid from passing under the wall. The attachment of the sidewall to the base may be made in any known manner and is preferably a permanent attachment.

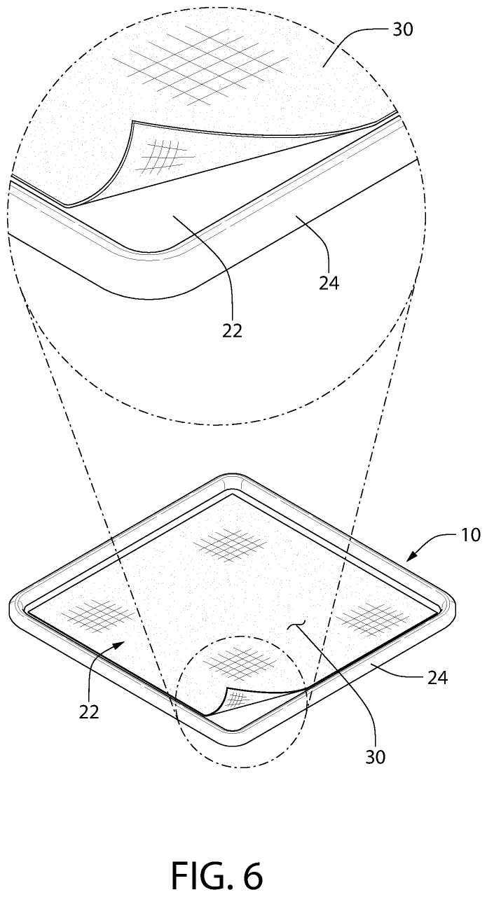

In FIG. 6, the device 10 is provided with a mat or other floor structure 30. The mat 30 is preferably flexible and formed separate from the base 22 (and sidewall 24). The mat 30 may be a resilient material preferably having a friction quality that is higher than that of the base material. The mat preferably defines a resilient standing surface and a frictional grip. The mat 30 may be relatively porous, such as by being formed as an open lattice. The mat 30 is contemplated to be added after inflation of the sidewalls 24. Preferably, the mat 30 covers the entire area inside of the sidewalls. However, the mat 30 may be smaller than to the overall base area and be positioned only under the surgeon or at an alternate location. The mat 30 is also contemplated to be disposed after a single surgical use.

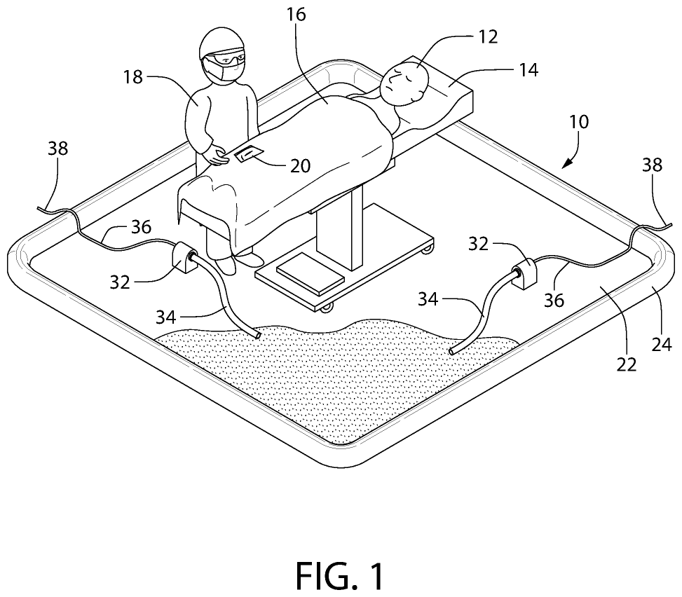

In FIG. 1 there is shown portable suction/pump apparatus 32. One or more apparatus 32 are placed strategically within the retention area defined by the base 22 and the sidewall 24. An inlet tube 34 is connected to the suction side of the apparatus 32. A separate outlet tube 36 is connected to the outlet side. The free end 38 of the tube 36 is positioned outside the capturing field and preferably connected to a drain or retention reservoir (not shown) to receive the exhausted fluids pumped from the capturing field. Examples of suction-pump devices include a WaterBoom (Registered Trademark) suction strip sold by the Aspen Surgical company of Caledonia, MI. The suction strip includes an elongated body that creates a localized dam to hold back and contain waste fluids. A Colby brand pump device also sold by Aspen Surgical may be attached to the strip. A Neptune brand surgical waste management system as sold by Stryker Corporation of Kalamazoo, MI may also be used, alone or in conjunction with the WaterBoom or similar suction-pump devices. Other suction and pumping devices may also be used.

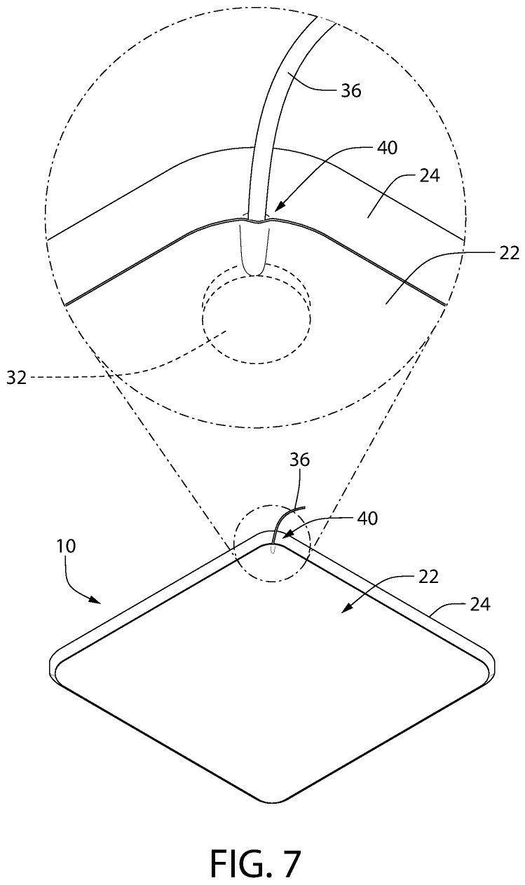

In FIG. 7, there is provided a relatively small opening 40 adjacent on or more corners of the sidewall 24. In embodiments, the openings 40 may be separation between the perimeter of the base 22 and adjacent portion of the sidewall 24. The openings 40 provides a space for the exhaust tube 36, as an example, to be connected to the suction-pump apparatus 32. Tube 36 may be passed under the sidewall 34 (rather than over the top, as shown in FIG. 1). These openings 40 may be provided at a number of locations along the sidewall perimeter. Means for selectively sealing the openings 40 when not being used or to otherwise seal around the tube may also be provided. The openings or gaps may also be created by formed separations in the sidewall. Adjacent chambers or chamber portions may form the overall perimeter of the device, with the openings or chambers positioned therebetween. The pressure in the separate chambers or chamber portions may force contact between the adjacent portions forming a separable seal.

As depicted in FIG. 1, a method of performing a surgical operation including the use of surgical irrigation fluids is defined by providing one or more medical personnel and an operating table within a retention area defined by a fluid retention device. The fluid retention device includes a base and a sidewall attached to the base. The sidewall defines the retention area on the base. Further, the sidewall is formed with a hollow interior that is expandable so that the sidewall is raised above a top surface of the base. The medical personnel and the operating table are positioned within the retention area during the surgical operation and the sidewall retains the exhausted medical fluids. A suction pump may be provided for moving surgical fluids from within the retention area and directing the fluids outside of the retention area. A mat structure may be provided on a top surface of the base and within the retention area. The mat structure preferably includes a resilient coating that forms a frictional standing surface for the medical personnel.

In the drawings and this specification, there is set forth one or more embodiments. Although specific terms are employed, these terms are used in a generic and descriptive sense and not necessarily for purposes of limitation. The scope of the invention is set forth in the claims.

What is claimed is:

1. A fluid retention device for retaining surgical fluids used during surgical operations, the device comprising:
a base,
a sidewall attached to the base and defining a retention area; and
the sidewall having a hollow interior that is selectively expanded to raise the sidewall from the base and define an upstanding perimeter around the retention area.

2. The fluid retention device as claimed in claim 1 wherein the retention area is sufficient to retain at least one medical personnel and an operating table, supporting a surgical patient.

3. The fluid retention device as claimed in claim 1 further comprising in combination:
suction pump means for suctioning the surgical fluids retained within the retention area defined by the sidewall and for strategically delivering the fluids through a pump tube and outside of the retention area.

4. The fluid retention device as claimed in claim 3 further comprising:
at least one opening provided adjacent a portion of the sidewall and providing space for allowing pump tubes to pass therethrough.

5. The fluid retention device as claimed in claim 4 wherein the at least one opening is formed at a corner position of the sidewall.

6. The fluid retention device as claimed in claim 4 wherein the at least one opening is formed by a separation between the sidewall and the base.

7. The fluid retention device as claimed in claim 1 further comprising in combination a mat structure positioned on a top surface of the base and within the retention area.

8. The fluid retention device as claimed in claim 7 wherein the mat structure includes a resilient coating and provides a frictional surface.

9. The fluid retention device as claimed in claim 1 wherein the sidewall defines a single hollow chamber forming the interior of the sidewall.

10. The fluid retention device as claimed in claim 1 further comprising port means attached to the sidewall for selectably sealing the hollow interior of the sidewall.

11. A method of performing a surgical operation including the use of surgical irrigation fluids, the method comprising:
providing at least one medical personnel for performing a surgical operation,
providing an operating table,
providing a fluid retention device comprising
a base,
a sidewall attached to the base and defining a retention area; and
the sidewall having a hollow interior and defining a perimeter around the retention area, and
expanding the sidewall so that the sidewall is raised above a top surface of the base,
wherein the at least one medical personnel and the operating table are positioned within the retention area during the surgical operation.

12. The method as claimed in claim 11 further comprising
providing a suction pump means for suctioning surgical fluids retained within the retention are and for directing the fluids outside of the retention area.

13. The method as claimed in claim 11 further comprising:
providing a mat structure on a top surface of the base and within the retention area.

14. The method as claimed in claim 13 wherein the mat structure includes a resilient coating that forms a frictional surface for the at least one medical personnel.

15. The method as claimed in claim 11 wherein the sidewall defines at least one hollow chamber and port means is attached to the sidewall for selectably sealing the hollow chamber.
